(19) United States
(12) Patent Application Publication
(10) Pub. No.: US 2014/0192047 A1
(43) Pub. Date: Jul. 10, 2014

(54) STEREOSCOPIC IMAGE DISPLAY DEVICE, IMAGE PROCESSING DEVICE, AND IMAGE PROCESSING METHOD

(71) Applicant: KABUSHIKI KAISHA TOSHIBA, Tokyo (JP)

(72) Inventors: Nao MISHIMA, Tokyo (JP); Takeshi MITA, Yokohama-shi (JP)

(73) Assignee: KABUSHIKI KAISHA TOSHIBA, Tokyo (JP)

(21) Appl. No.: 14/208,726

(22) Filed: Mar. 13, 2014

Related U.S. Application Data
(63) Continuation of application No. PCT/JP2011/076288, filed on Nov. 15, 2011.

(51) Int. Cl. G06T 15/00

(52) U.S. Cl. CPC G06T 15/00
USPC 345/419

(57) ABSTRACT

According to an embodiment, a stereoscopic image display device includes a display, a determiner, a generator, and a display controller. The display is configured to display a stereoscopic image which includes a plurality of parallax images having mutually different parallaxes. The determiner is configured to determine the number of parallaxes in such a way that, the larger a viewing distance from the display to a viewer, the smaller becomes the interval between light beams which belong to each of the parallax images and which are emitted from the display. The generator is configured to generate the parallax images in number corresponding to the number of parallaxes. The display controller is configured to display the parallax images on the display.

### CROSS-REFERENCE TO RELATED APPLICATIONS

This application is a continuation of PCT international application Ser. No. PCT/JP2011/076288 filed on Nov. 15, 2011 which designates the United States; the entire contents of which are incorporated herein by reference.

### FIELD

An embodiment described herein relates generally to a stereoscopic image display device, an image processing device, and an image processing method.

### BACKGROUND

Stereoscopic image display devices enable viewers to view stereoscopic images with the unaided eye and without having to put on special glasses. In such a stereoscopic image display device, a plurality of images having mutually different viewpoints (a plurality of parallax images) is displayed, and the light beams coming out from the images are controlled using a light beam control element such as a parallax barrier or a lenticular lens. The controlled light beams are then guided to both eyes of a viewer, thereby enabling him or her to recognize stereoscopic images. Herein, the area within which the viewer is able to view stereoscopic images is called a visible area.

Conventionally, a technology is known in which the visible area is varied dynamically by varying the pitch of the apertures that are formed in the light beam control element with the aim of emitting the light beams coming out from the pixels toward a predetermined direction.

However, in the conventional technology, it is not possible to vary the distance between the light beams (i.e., the light beam interval) in each parallax image. For that reason, if a viewing distance, which indicates the distance between a stereoscopic image display device and a viewer, is large; then, at the position that is away from the stereoscopic image display device by a distance equal to the viewing distance, the light beam interval exceeds a value (such as the interocular distance) that enables the viewer to view stereoscopic images. Therefore, the stereoscopic images cannot be viewed.

### BRIEF DESCRIPTION OF THE DRAWINGS

FIG. 1 is a diagram illustrating an example of a stereoscopic image display device according to an embodiment;

FIG. 2 is a conceptual diagram of the control performed by a display controller according to the embodiment;

FIGS. 3A and 3B are diagrams for explaining the relationship between the pixel pitch and the light beam interval;

FIG. 4 is a diagram for explaining a condition that enables making changes in the light beam interval;

FIG. 5 is a diagram for explaining an apparent pixel pitch in an oblique direction;

FIG. 6 is a diagram for explaining a method of calculating the light beam interval;

FIG. 7 is a diagram illustrating a configuration example of a controller according to the embodiment;

FIG. 8 is a diagram for explaining an exemplary method of generating parallax images;

FIG. 9 is a diagram for explaining an exemplary method of generating parallax images;

FIG. 10 is a diagram for explaining an exemplary method of assigning pixels that display parallax images;

FIG. 11 is a diagram for explaining an exemplary method of assigning pixels that display parallax images;

FIG. 12 is a diagram of an exemplary display in the case when the number of parallaxes is determined to be three;

FIG. 13 is a diagram of an exemplary display in the case when the number of parallaxes is determined to be six; and

FIG. 14 is a flowchart for explaining an example of the operations performed in the controller.

### DETAILED DESCRIPTION

According to an embodiment, a stereoscopic image display device includes a display, a determiner, a generator, and a display controller. The display is configured to display a stereoscopic image which includes a plurality of parallax images having mutually different parallaxes. The determiner is configured to determine the number of parallaxes in such a way that, the larger a viewing distance from the display to a viewer, the smaller becomes the interval between light beams which belong to each of the parallax images and which are emitted from the display. The generator is configured to generate the parallax images in number corresponding to the number of parallaxes. The display controller is configured to display the parallax images on the display.

An exemplary embodiment of a stereoscopic image display device, an image processing device, and an image processing method according to the invention is described below in details with reference to the accompanying drawings.

In a stereoscopic image display device 1 according to an embodiment, a plurality of parallax images having mutually different parallaxes are displayed so as to enable a viewer to view stereoscopic images. Herein, in the stereoscopic image display device 1, it is possible to implement a 3D display method such as the integral imaging method (II method) or the multi-view method. Examples of the stereoscopic image display device 1 include a TV, a PC, a smartphone, or a digital photo frame that enables a viewer to view a stereoscopic image with the unaided eye.

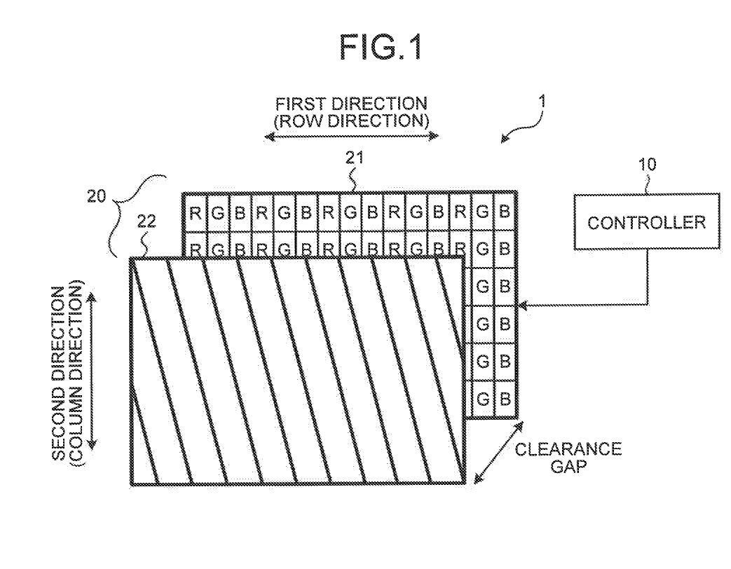

FIG. 1 is an outline drawing of the stereoscopic image display device 1 according to the embodiment. The stereoscopic image display device 1 includes a controller 10 and a display 20. The controller 10 is a device that controls the display on the display 20, and corresponds to the image processing device according to the invention. The details of the controller 10 are given later.

The display 20 is a device capable of displaying a stereoscopic image that includes a plurality of parallax images having mutually different parallaxes. As illustrated in FIG. 1, the display 20 includes a display element 21 and a light beam control element 22.

The parallax images are images constituting a stereoscopic image and are used in enabling a viewer to view the stereoscopic image. In a stereoscopic image, the pixels of each parallax image are assigned in such a way that, when a viewer views the display element 21 from his or her viewing position and through the light beam control element 22, a particular parallax image is seen to one eye of the viewer and another parallax image is seen to the other eye of the viewer. That is, the stereoscopic image is generated by rearranging the pixels of each parallax image. Meanwhile, in a parallax image, a single pixel includes a plurality of sub-pixels.

The display element 21 is a liquid crystal panel in which a plurality of sub-pixels having different colors (such as R, G, and B) is arranged in a matrix-like manner in a first direction (the row direction) and a second direction (the column direction). Alternatively, the display element 21 can be a flat-panel display such as an organic EL panel or a plasma panel. Moreover, the display element 21 illustrated in FIG. 1 is assumed to include a light source such as a backlight. In the example illustrated in FIG. 1, a single pixel is made of RGB sub-pixels. In the first direction, the sub-pixels are repeatedly arranged in the order of R (red), C (green), and B (blue). In the second direction, the sub-pixels of the same color component are arranged.

The light beam control element 22 controls the direction of the light beam that is emitted from each sub-pixel of the display element 21. The light beam control element 22 has a plurality of linearly-extending optical apertures arranged in the first direction for the purpose of emitting light beams. In the example illustrated in FIG. 1, the light beam control element 22 is a lenticular sheet on which is arranged a plurality of cylindrical, lenses (which function as the optical apertures). However, that is not the only possible case. Alternatively, for example, the light beam control element 22 can be a parallax barrier having a plurality of slits arranged thereon. Herein, a fixed distance (clearance gap) is maintained between the display element 21 and the light beam control element 22. Moreover, the light beam control element 22 is disposed in such a way that the extending direction of the optical apertures thereof has a predetermined tilt with respect to the second direction (the column direction) of the display element 21. As a result, there occurs a misalignment along the row direction in the positions of the optical apertures and display pixels. Hence, for each different height, there is a different visible area (i.e., the area within which a stereoscopic image can be viewed).

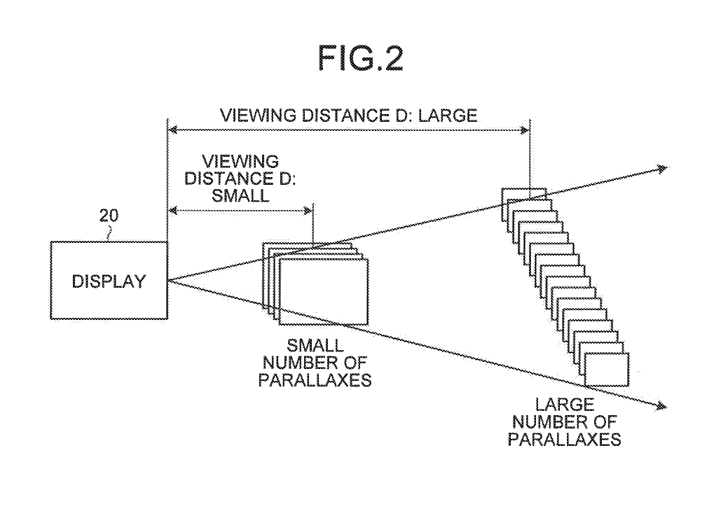

FIG. 2 is a conceptual diagram of the control performed by the controller 10 according to the embodiment. As illustrated in FIG. 2, the controller 10 according to the embodiment sets the number of parallaxes in such a way that, larger a viewing distance D, larger becomes the number of parallaxes. With that, larger the viewing distance D, smaller becomes the light beam interval (i.e., the interval between the light beams of each parallax image that are emitted from the display 20). As a result, even in the case when the viewing distance D is large, it becomes possible to prevent a situation in which the light beam interval at the position that is away from the display 20 by a distance equal to the viewing distance D exceeds the value that enables viewers to view>stereoscopic images. Given below are the specific details of the controller 10.

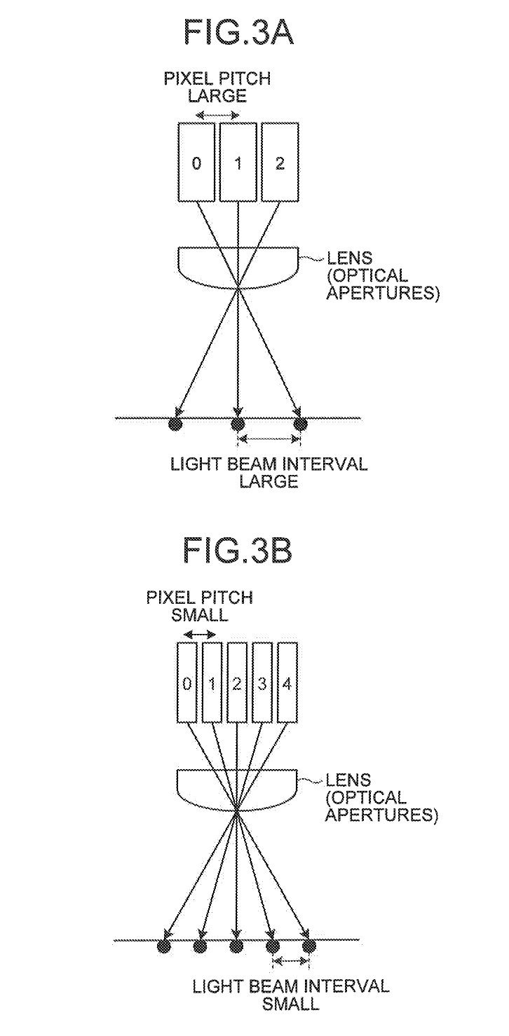

Firstly, prior to giving the specific details of the controller 10, the explanation is given about the condition that enables making changes in the light beam interval. Herein, the light beam interval is determined according to the optical apertures (in the example given in the embodiment, a lens (a cylindrical lens)) and the pixel pitch. As illustrated in FIG. 3A, when the pixel pitch is large, the light beam interval also becomes large. As illustrated in FIG. 3B, when the pixel pitch is small, the light beam interval also becomes small. In FIGS. 3A and 3B, the numbers assigned to the pixels represent the numbers assigned to the parallax images (i.e., represent parallax numbers). In the example illustrated in FIG. 3A, the number of parallaxes is three (parallax numbers 0 to 2). In the example illustrated in FIG. 3B, the number of, parallaxes is five (parallax numbers 0 to 4),

Herein, if the light beam control element 22 is placed in such a way that the extending direction of the lens is parallel to the column direction of the display element 21 (i.e., if the light beam control element 22 is placed perpendicular to the display element 21), then the light beam interval gets uniquely determined with respect to the pixel pitch. However, if the light beam control element 22 is placed at a tilt with respect to the display element 21, then the light beam interval may vary depending on the angle representing the relative tilt of the light beam control element 22 with respect to the display element 21 (in this example, the angle made by the second direction of the display element 21 with the extending direction of the lens).

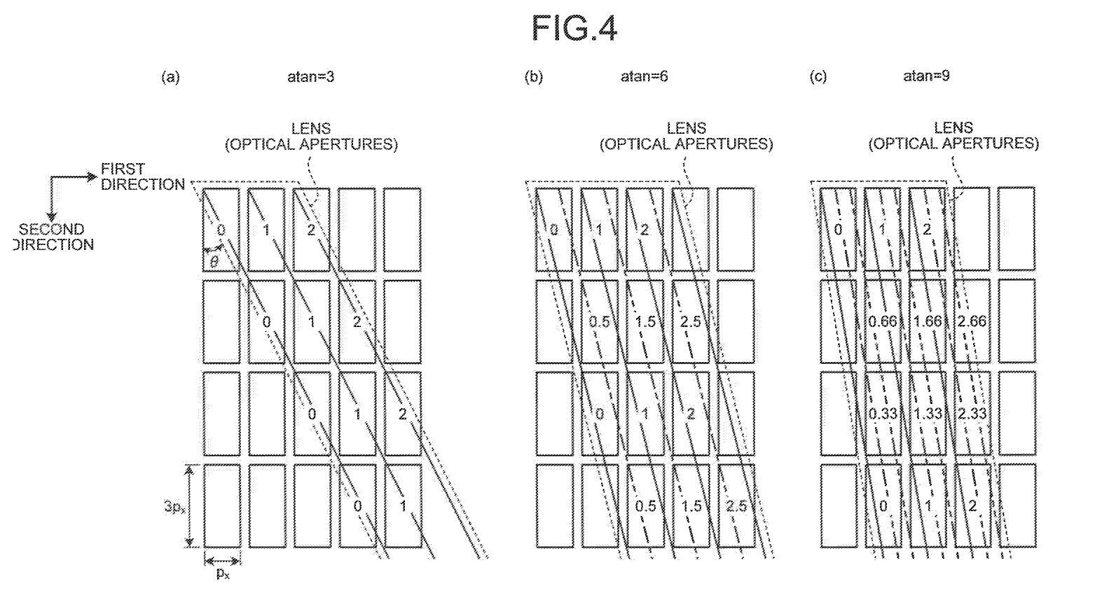

Explained below with reference FIG. 4 is a relationship between an angle θ, which represents the relative tilt of the light beam control element 22 with respect to the display element 21, and the light beam interval. In this example, it is assumed that a pixel size (px, py)=(px, 3px) is satisfied. That is, the size py in the vertical direction (the second direction) of a pixel is thrice the size px in the horizontal direction (the first direction). Meanwhile, an FIG. 4, the numbers assigned to the pixels represent the numbers assigned to the parallax images, and the pixels having the same number assigned thereto display the same parallax image.

In the example illustrated in part (a) of FIG. 4, tan θ=px/3px=1/3 is satisfied. In the following explanation, the relative tilt of the light beam control element 22 with respect to the display element 21 is expressed as 1/tan θ, and 1/tan θ is written as a tan. In the example illustrated in part (a) of FIG. 4, a tan=3 is satisfied. In this case, the light beam interval is determined according to only the pixel pitch.

In contrast, in the example illustrated in part (b) of FIG. 4, a tan=6 is satisfied. In this case, the number of parallaxes can be set to either “3” or “6”. If the number of parallaxes is set to “3”; for example, the parallax images having the parallax numbers 0, 1, and 2 are displayed, thereby enabling achieving three parallaxes. If the number of parallaxes is set to “6”; for example, the parallax images having the parallax numbers 0, 0.5, 1, 1.5, 2, and 2.5 are displayed, thereby enabling achieving six parallaxes. In this case, as compared to the case of having the number of parallaxes equal to “3”, the apparent pixel pitch in an oblique lens direction becomes equal to half. That is, in the example illustrated in part (b) of FIG. 4, if the number of parallaxes is doubled, the light beam interval can be reduced to half.

In the example illustrated in part (c) of FIG. 4, a tan=9 is satisfied. In this case, the number of parallaxes can be set to either “3” or “6”, or “9”. If the number of parallaxes is set to “3”; for example, the parallax images having the parallax numbers 0, 1, and 2 are displayed, thereby enabling achieving three parallaxes. If the number of parallaxes is set to “6”; for example, the parallax images having the parallax numbers 0, 0.33 (or 0.66), 1, 1.33 (or 1.66), 2, and 2.33 (or 2.66) are displayed, thereby enabling achieving six parallaxes. If the number of parallaxes is set to “9”; for example, the parallax images having the parallax numbers 0, 0.33, 0.66, 1, 1.33, 1.66, 2, 2.33, and 2.66 are displayed, thereby enabling achieving nine parallaxes. In this case, as compared to the case of having the number of parallaxes equal to “3”, the apparent pixel pitch in the oblique lens direction becomes equal to one third. That is in the example illustrated in part (c) of FIG. 4, if the number of parallaxes is tripled, the light beam interval can be reduced to one third. In this way, in order to enable making a change in the light beam interval; the angle θ, which represents the relative angle of the light beam control element 22 with respect to the display element 21, assumes importance. That is, the angle θ needs to be set to a value that enables making changes in the light beam interval.

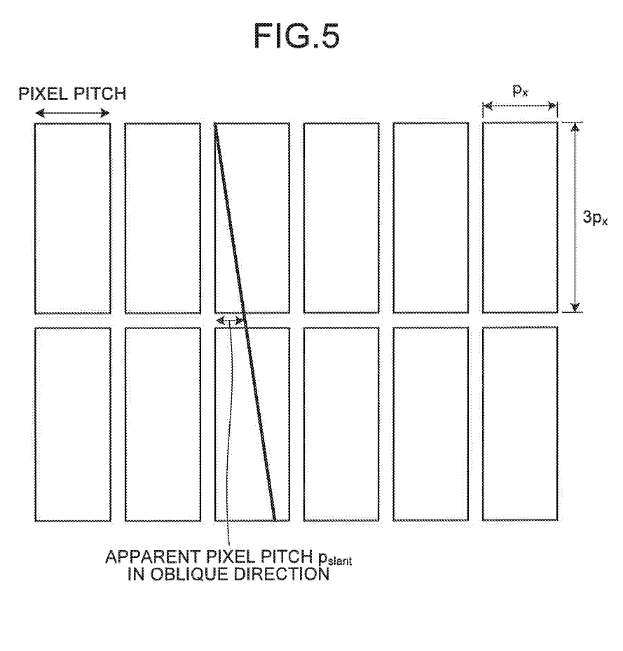

As illustrated in FIG. 5, an apparent pixel pitch pₛₗₐₙₜ in an oblique direction can be acquired from a triangular similarity relationship using Expression (1) given below.

$${p}_{x} \text{:} atan \cdot {p}_{x} = {p}_{slant} \text{:} 3 {p}_{x} \\ {p}_{slant} = \frac{3 {p}_{x}}{atan} \qquad ( 1 )$$

Then, the number of light beams per line/per pixel can be acquired as px/pₛₗₐₙₜ=a tan/3.

Herein, such a T for which pₛₗₐₙₜ×T is an integer (or a value closer to an integer) is called a maximum cycle. Moreover, the number of light beams N_{L} is the result of multiplying the minimum number of lines of pixels (hereinafter, called “the number of vertical lines”) y_{3d}, which is required to display parallax images in number corresponding to the number of parallaxes that is set, by the number of pixels Xₙ in the width direction (the first direction) under the lens. Thus, the number of light beams N_{L} can be expressed as Expression (2) given below.

N_{L}=Xₙ×y_{3d} (2)

Herein, the number of vertical lines y_{3d} falls in the range of 1≦y_{3d}≦T. In the example illustrated in part (a) of FIG. 4, the maximum cycle T=1 is satisfied, and “1” is the minimum number of lines (the number of rows) of pixels required to display the parallax images having the parallax numbers 0, 1, and 2, Hence, the number of vertical lines y_{3d} cannot take any value other than 1. Since the number of pixels Xₙ in the width direction under the lens is three, the number of light beams N_{L}=3×1=3 is satisfied.

In the example illustrated in part (b) of FIG. 4, the maximum cycle T=2 is satisfied, and the number of vertical lines y_{3d} falls in the range of 1≦y_{3d}≦2. If the number of parallaxes is set to “3”, then “1” is the minimum number of lines of pixels required to display three parallax images (having the parallax numbers 0, 1, and 2). Hence, the number of vertical lines y_{3d} becomes equal to one, and the number of light beams N_{L}=3×1=3 is satisfied. If the number of parallaxes is set to “6”, then “2” is the minimum number of lines of pixels required to display six parallax images (having the parallax numbers 0, 0.5, 1, 1.5, 2, and 2.5). Hence, the number of vertical lines y_{3d} becomes equal to two, and the number of light beams N_{L}3×2=6 is satisfied.

In the example illustrated in part (c) of FIG. 4, the maximum cycle T=3 is satisfied, and the number of vertical lines y_{3d} falls in the range of 1≦y_{3d}≦3. If the number of parallaxes is set to “3”, then “1” is the minimum number of lines of pixels required to display three parallax images (having the parallax numbers 0, 1, and 2). Hence, the number of vertical lines y_{3d} becomes equal to one, and the number of light beams N_{L}3×1=3 is satisfied. If the number of parallaxes is set to “6”, then “2” is the minimum number of lines of pixels required to display six parallax images (having the parallax numbers 0, 0.33 (0.66), 1, 1333 (1.66), 2, 2.33 (2.66)). Hence, the number of vertical lines y_{3d} becomes equal to two, and the number of light beams N_{L}=3×2=6 is satisfied. If the number of parallaxes is set to “9”, then “3” is the minimum number of lines of pixels required to display nine parallax images (having the parallax numbers 0, 0.33, 0.66, 1, 1.33, 1.66, 2, 2.33, 2.66). Hence, the number of vertical lines y_{3d} becomes equal to three, and the number of light beams N_{L}=3×3=9 is satisfied.

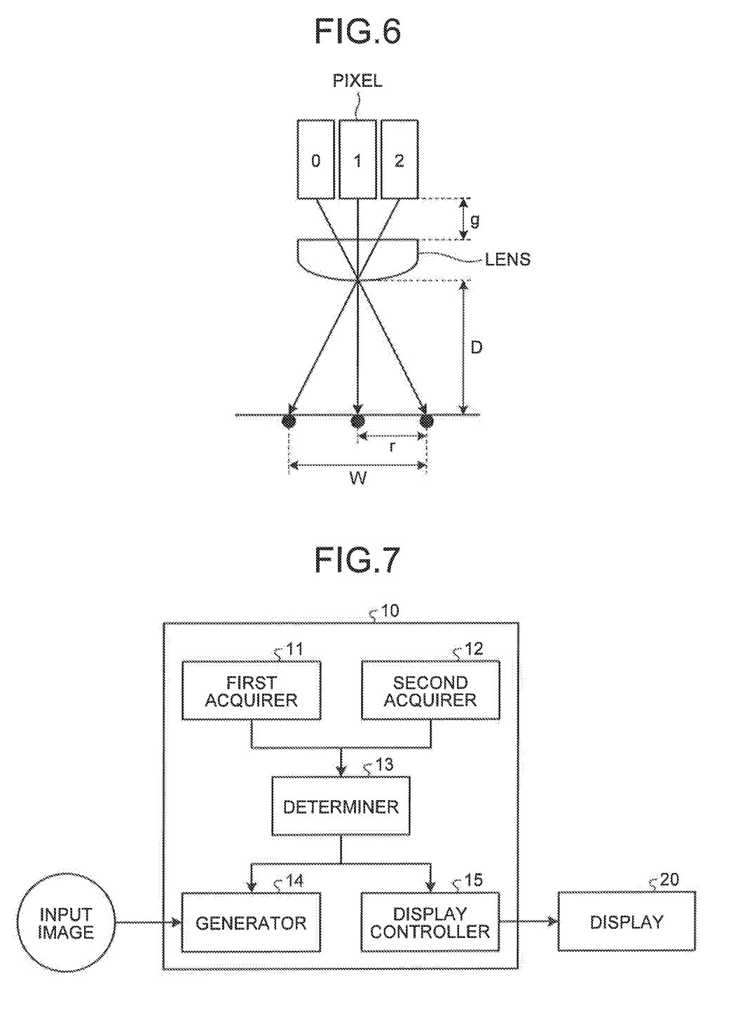

Meanwhile, as illustrated in FIG. 6, when D represents the viewing distance and when g represents a gap (a clearance gap) between the pixels and the lens, a visible width W at the viewing distance D can be expressed using Expression (3) given below.

W=(D×Xₙ×px)/g (3)

If the visible width W is divided by the number of light beams N_{L}, then a light beam interval r at the viewing distance D is acquired. Herein, the light beam interval r at the viewing distance D can be expressed using Expression (4) given below,

R=W/N_{L}=Dpx/gy_{3d} (4)

That is, larger the number of vertical lines y_{3d} (larger the number of parallaxes that is set), smaller becomes the light beam interval r.

Given below are the specific details of the controller 10. FIG. 7 is a block diagram illustrating a configuration example of the controller 10. As illustrated in FIG. 7, the controller 10 includes a first acquirer 11, a second acquirer 12, a determiner 13, a generator 14, and a display controller 15.

The first acquirer 11 acquires tilt information that indicates the relative tilt between the display element 21 and the light beam control element 22. In the embodiment, as the tilt information, the first acquirer 11 acquires the a tan mentioned above. However, that is not the only possible case. For example, a as the tilt information, the first acquirer 11 can acquire information related to the angle indicating the tilt of the light beam control element 22 (for example, the angle made between the second direction of the display element 21 and the extending direction of the lens) or can acquire information related to the dimensions of the pixels and the lens. In essence, as long as the first acquirer 11 acquires information that indicates the relative tilt between the display element 21 and the light beam control element 22, it serves the purpose. Meanwhile, the method of acquiring the tilt information can be arbitrary. For example, the first acquirer 11 can access an external device and acquire the tilt information from the external device. Alternatively, for example, the first acquirer 11 can access a memory in which the tilt information is stored, and read the tilt information from the memory.

The second acquirer 12 acquires the viewing distance D mentioned above. The method of acquiring the viewing distance D can be arbitrary. For example, an imaging device such as a camera can be attached to the display 20, and the second acquirer 12 can receive an image captured by the imaging device and calculate the viewing distance based on the image. For example, the face position of a viewer appearing in a captured image can be detected, and the viewing distance D can be calculated from the detected face position. Alternatively, for example, the second acquirer 12 can receive a specified input of the viewing distance D from a viewer or an operator, and accordingly acquire the viewing distance D. Sill alternatively, for example, the second acquirer 12 can access an external device and acquire the viewing distance D from the external device, or can access a memory in which the viewing distance D is stored and read the viewing distance from the memory.

The determiner 13 determines the number of parallaxes in such a way that, larger the value of the viewing distance D acquired by the second acquirer 12, smaller is the distance between the light beams of each parallax image that are emitted from the display 20 (i.e., smaller is the light beam interval). More particularly, the determiner 13 determines the number of parallaxes in such a way that, larger the value of the viewing distance D acquired by the second acquirer 12, larger becomes the number of parallaxes. The details of the determiner 13 are given later.

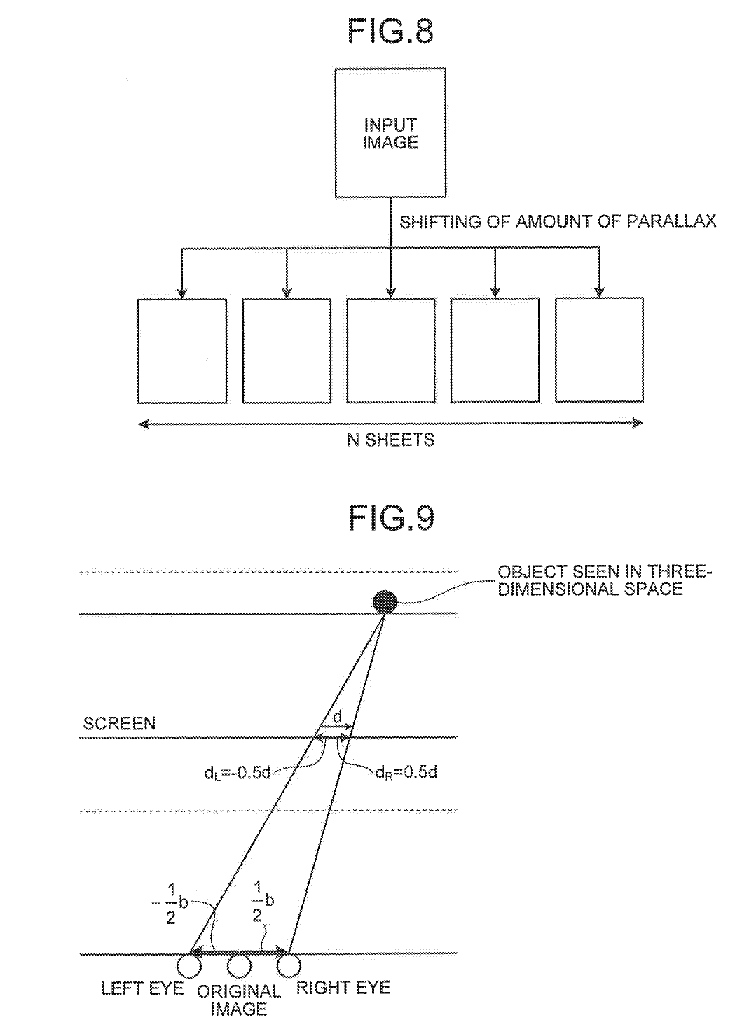

The generator 14 generates parallax images in number corresponding to the number of parallaxes determined by the determiner 13. More particularly, the generator 14 generates a required number of parallax images based on an input image that is input from the outside and based on the number of parallaxes that is determined by the determiner 13. For example, in the case of generating N (N≧2) number of parallax images; as illustrated in FIG. 8, the generator 14 shifts the input image according the amount of parallax and generates N number of parallax images. Meanwhile, the method of generating parallax images can be arbitrary, and various known technologies can be implemented.

As an example, explained below with reference to FIG. 9 is a method of generating parallax images when the number of parallaxes is “2”. In the example illustrated in FIG. 9, the parallax image corresponding to the left eye (one viewpoint) of a viewer is called a left parallax image and the parallax image corresponding to the right eye (another viewpoint) of the viewer is called a right parallax image. Moreover, an input image is assumed to be positioned in the center between the left parallax image and the right parallax image. If “d” represents a parallax vector indicating the amount of parallax between the left parallax image and the right parallax image; then the right parallax image can be calculated from the input image and from a parallax vector d_{R}=0.5d indicating the amount of parallax between the input image and the right parallax image, and the left parallax image can be calculated from the input image and from a parallax vector d_{L}=−0.5d indicating the amount of parallax between the input image and the left parallax image. That is, the left parallax image can be generated by shifting pixel values I (x, y) of the input image according to d_{L}. The right parallax image can also be generated in an identical manner. Meanwhile, simply performing a shift according to the parallax vector may result in the formation of a hole. In that case, the hole region can be filled with a picture by means of interpolation from the surrounding parallax vectors. Herein, although the explanation is given for an example of having two parallaxes, the same operations can be performed for more than two parallaxes. Moreover, in the case when an input image and a depth map are provided, it is possible to perform the same operations. In that case, the generator 14 firstly converts a depth value into the parallax vector d, and then generates parallax images in number corresponding to the number of parallaxes with the use of the parallax vector d acquired by means of conversion. Furthermore, the generator 14 can also directly generate the parallax images from CG modeling data or volume data.

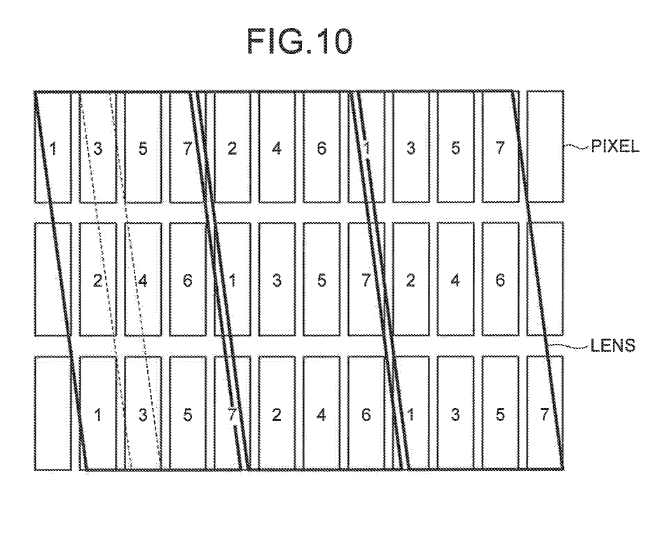

Returning to the explanation with reference to FIG. 7, the controller 10 displays the parallax images, which are generated by the generator 14, on the display 20. More particularly, the controller 10 displays the parallax images, which are generated by the generator 14, by assigning them to the pixels of the display elements. In the embodiment, as illustrated in FIG. 10, since the lens is placed at a tilt on the pixels, the pixels viewable through the lens are, for example, seen along the dotted lines illustrated in FIG. 10. That is, in the display element 21, a plurality of pixels is arranged along the horizontal direction and the vertical direction. However, since the lens is placed at a tilt, while assigning the pixels for displaying the parallax images (while performing pixel mapping), it is necessary to assign the pixels in accordance with the extending direction of the lens. In the example illustrated in FIG. 10, assignment is performed for the pixels that display each of seven parallax images (having the parallax numbers 1 to 7). Herein, the pixels having the same number assigned thereto display the same parallax image. Of a plurality of pixels arranged in the display element 21, retarding a pixel (k, l) that is subjected to pixel mapping, a parallax number v can be acquired using Expression (6) given below.

$$v = \frac{( k + koffset - 3 l \cdot atan \cdot mod {X}_{n} )}{{X}_{n}} N \qquad ( 6 )$$

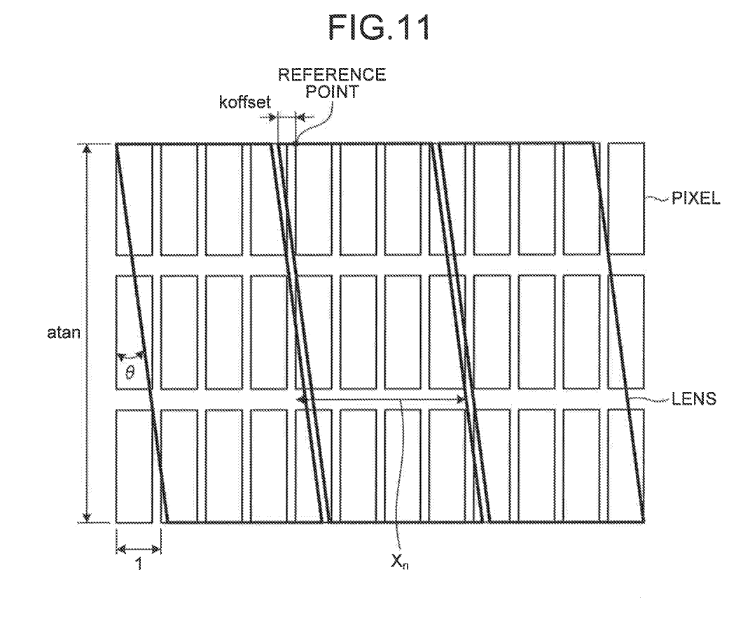

In Expression (6), koffset represents the positional shift between an image and the lens, and the unit thereof is pixels. In the example illustrated in FIG. 11, the upper left end of an image is treated as the reference point (origin), and the amount of shift between that reference point and the upper left end of the lens represents koffset.

The parallax number v is a continuous value. However, since the parallax images are discreet in nature, the parallax number v cannot be assigned as it is to a parallax image. In that regard, linear interpolation or three-dimensional interpolation is performed. In this way, the display controller 15 displays the parallax images, which are generated by the generator 14, on the display 20.

Given below is the explanation of the details of the determiner 13. In the embodiment, the determiner 13 determines the number of parallaxes based on the tilt information, which is acquired by the first acquirer 11, and the viewing distance D, which is acquired by the second acquirer 12. Following are the specific details. Using the tilt information, which is acquired by the first acquirer 11, and the viewing distance D, which is acquired by the second acquirer 12; the determiner 13 calculates the light beam interval r at the position that is away from the display 20 by a distance equal to the viewing distance D. More particularly, from the tilt information (in this example, a tan) acquired by the first acquirer 11, the determiner 13 acquires the supposed number of vertical lines y_{3d}. Then, using the number of vertical lines y_{3d} and the viewing distance D acquired by the second acquirer 12, the determiner 13 acquires the light beam interval r=Dpx/gy_{3d} (see Expression (4) given above) at the position that is away from the display 20 by a distance equal to the viewing distance D.

Herein, at the position of the viewing distance D, in order to ensure that a viewer is able to view stereoscopic images, the light beam interval r at the viewing distance D needs to be equal to or smaller than a reference value that is set to enable viewers to view stereoscopic images. As an example, in the embodiment, an interocular distance b representing the distance between the eyes of viewers is used as the reference value. In this example, the determiner 13 holds in advance the value of the interocular distance b, and determines the number of parallaxes in such a way that the light beam interval r at the viewing distance D is equal to or smaller than the interocular distance b. The condition for which the light beam interval r at the viewing distance D becomes equal to or smaller than the interocular distance b can be expressed using Expression (5) given below.

Dpx/gy_{3d}≦b (5)

As described above, the number of vertical lines y_{3d} falls in the range of 1≦y_{3d}≦T. The determiner 13 determines the number of vertical lines y_{3d} in such a way that, within the abovementioned range, y_{3d}≧Dpx/gb that is a modification of Expression (5) given above is satisfied. If a plurality of numbers of vertical lines y_{3d} satisfies the condition, then the determiner 13 selects the smallest number of vertical lines y_{3d}. Then, the number of parallaxes (the number of light beams N_{L})=Xₙ×y_{3d} can be determined using the selected number of vertical lines v_{3d}.

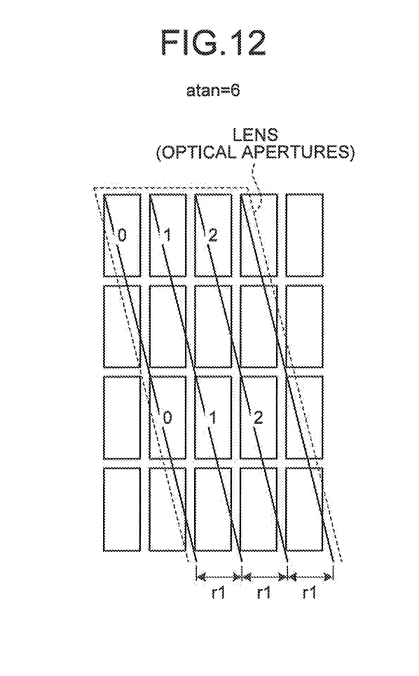

Herein, the explanation is given for an example in which the tilt information a tan=6 (as illustrated in part (b) of FIG. 4) is acquired by the first acquirer 11. Assume that a viewing distance D1 is acquired by the second acquirer 12. In this case, the settable number of parallaxes is either three or six. Hence, the maximum cycle T=2 is satisfied and the number of vertical lines y_{3d} is either one or two. As described above, of the supposed numbers of lines y_{3d}, the determiner 13 selects the number of vertical lines y_{3d} that satisfy y_{3d}≧D1px/gb. In this example, if the viewing distance D1 is smaller than a predetermined value, then y_{3d}≧D1px/gb is satisfied not only when the number of vertical lines y_{3d} is one but also when the number of vertical lines y_{3d} is two. Hence, of the numbers of vertical lines y_{3d} that satisfy the condition, the determiner 13 determines the smallest number of vertical lines y_{3d} equal to “1” and determines the number of parallaxes. Herein, since the number of pixels Xₙ in the width direction (the first direction) under the lens is three, the number of light beams N_{L}=3×1=3 is satisfied. In this case, for example, as illustrated in FIG. 12, parallax images having the parallax numbers 0, 1, and 2 are generated; and assignment of the pixels displaying those parallax images are performed.

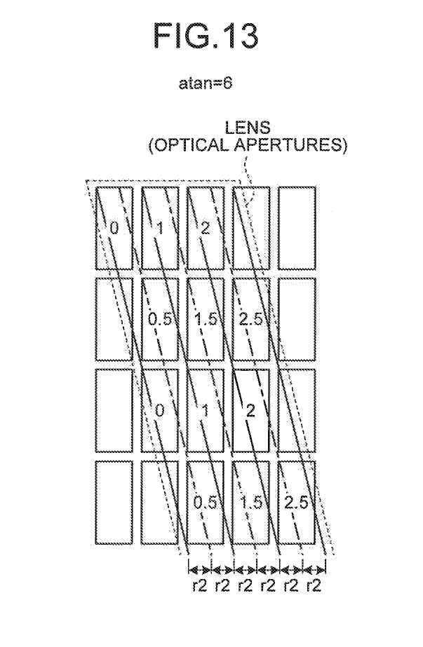

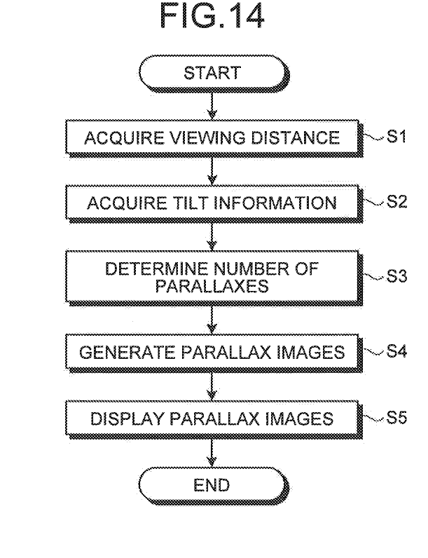

On the other hand, in this example, if the viewing distance D1 is equal to or larger than the predetermined value, then y_{3d}≧D1px/gb is satisfied only when the number of vertical lines y_{3d} is “2”. Hence, the determiner 13 selects the number of vertical lines y_{3d} of “2” and determines the number of parallaxes. In this case, the number of parallaxes becomes 2×3=6. In this case, for example, as illustrated in FIG. 13, parallax images having the parallax numbers 0, 0.5, 1, 1.5, 2, and 2.5 are generated; and assignment of the pixels displaying those parallax images are performed. In this case, a light beam interval r2 becomes half of a light beam interval r1 (see FIG. 12) in the case when the number of parallaxes is three. Thus, the determiner 13 determines the number of parallaxes in such a way that, larger the viewing distance D, smaller becomes the light beam interval r.

FIG. 14 is a flowchart for explaining an example of the operations performed in the controller 10. The second acquirer 12 acquires the viewing distance (Step S1). The first acquirer 11 acquires the tilt information (Step S2) Herein, the first acquirer 11 can acquire the tilt information before the second acquirer 12 acquires the viewing distance. Then, the determiner 13 determines the number of parallaxes based on the tilt information, which is acquired by the first acquirer 11, and the viewing distance, which is acquired by the second acquirer 12 (Step S3). Subsequently, the generator 14 generates parallax images in number corresponding to the number of parallaxes determined by the determiner 13 (Step S4). Then, the display controller 15 displays the parallax images, which are generated by the generator 14, on the display 20 (Step S5).

As described above, in the embodiment, the number of parallaxes is determined in such a way that, larger the viewing distance D, smaller becomes the light beam interval r. Hence, even if the viewing distance D is large, it becomes possible to prevent a situation in which the light beam interval r at the viewing distance D exceeds the value that enables viewers to view stereoscopic images. That is, according to the embodiment, a stereoscopic image display device can be provided that, even if the viewing distance is large, enables a viewer to view stereoscopic images.

In the embodiment described above, the light beam control element 22 is placed at a tilt with respect to the display element 21. However, that is not the only possible case. Alternatively, for example, the light beam control element 22 can be placed in such a way that the extending direction of the optical apertures thereof is parallel to the second direction (the column direction) illustrated in FIG. 1; and the display element 21 can be placed at a tilt with respect to the light beam control element 22. Thus, in essence, as long as the display unit displays a plurality of parallax images in such a way that there is a different visible area for each different height, it serves the purpose. Meanwhile, for example, the configuration of the display unit can also be such that the light beam control element 22 is placed in such a way that the extending direction of the optical apertures thereof is parallel to the column direction of the display element 21 (in other words, the light beam control element 22 is placed in such a way that the extending direction of the optical apertures thereof is not at a predetermined tilt with respect to the column direction of the display element 21). Thus, as long as the number of parallaxes is determined in such a way that, larger the viewing distance D, smaller becomes the light beam interval r; it serves the purpose.

Meanwhile, the controller 10 according to the embodiment described above has the hardware configuration that includes a CPU (Central Processing Unit), a ROM, a RAM, and a communication I/F device. Herein, the functions of each of the abovementioned constituent elements are implemented when the CPU loads programs, which are stored in the ROM, in the RAM and executes those programs. However, that is not the only possible case. Alternatively, at least some of the functions of the constituent elements can be implemented using individual circuits (hardware). For example, at least the determiner 13, the generator 14, and/or the display controller 15 may be configured from a semiconductor integrated circuit.

Meanwhile, the programs executed in the controller 10 according to the embodiment described above can be saved as downloadable files on a computer connected to the Internet or can be made available for distribution through a network such as the Internet. Alternatively, the programs executed in the controller 10 according to the embodiment described above can be stored in advance in a ROM or the like.

Alternatively, some or all of the functions of the abovementioned constituent elements can be realized by both software and hardware.

While certain embodiments have been described, these embodiments have been presented by way of example only, and are not intended to limit the scope of the inventions. Indeed, the novel embodiment described herein may he embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A stereoscopic image display device comprising:
a display configured to display a stereoscopic image which includes a plurality of parallax images having mutually different parallaxes;
a determiner configured to determine the number of parallaxes in such a way that, larger a viewing distance from the display to a viewer, smaller becomes the interval between light beams which belong to each of the parallax images and which are emitted from the display;
a generator configured to generate the parallax images in number corresponding to the number of parallaxes; and
a display controller configured to display the parallax images on the display.

2. The device according to claim 1, wherein
the display includes a display element, in which pixels are arranged in a matrix-like manner, and includes a light beam control element, which controls the travelling direction of light beams emitted from the display element,
the device further comprises:
a first acquirer configured to acquire tilt information which indicates a relative tilt between the display element and the light beam control element,
a second acquirer configured to acquire the viewing distance, and
the determiner determines the number of parallaxes based on the tilt information and the viewing distance.

3. The device according to claim 2, wherein, the determiner
calculates, using the tilt information and the viewing distance, an interval between light beams of each of the parallax images at a position that is away from the display by a distance equal to the viewing distance, and
determines the number of parallaxes in such a way that the calculated interval has a value which enables the viewer to view the stereoscopic image.

4. The device according to claim 3, wherein the determiner determines the number of parallaxes in such a way that the calculated interval is equal to or smaller than an interocular distance indicating the distance between eyes of the viewer.

5. The device according to claim 1, wherein the determiner determines the number of parallaxes in such a way that, larger the viewing distance, larger becomes the number of parallaxes.

6. The device according to claim 1, wherein at least the determiner, the generator, and the display controller are implemented as a processor.

7. An image processing device comprising:
a determiner configured to determine the number of parallaxes in such a way that, larger a viewing distance between a viewer and a display that is capable of displaying a stereoscopic image which includes a plurality of parallax images having mutually different parallaxes, smaller becomes the interval between light beams which belong to each of the parallax images and which are emitted from the display;
a generator configured to generate the parallax images in number corresponding to the number of parallaxes; and
a display controller configured to display the parallax images on the display.

8. An image processing method comprising:
determining the number of parallaxes in such a way that, larger a viewing distance between a viewer and a display that is capable of displaying a stereoscopic image which includes a plurality of parallax images having mutually different parallaxes, smaller becomes the interval between light beams which belong to each of the parallax images and which are emitted from the display;
generating the parallax images in number corresponding to the number of parallaxes; and
displaying the generated parallax images on the display.
